(19) United States
(12) Patent Application Publication
(10) Pub. No.: US 2014/0295385 A1
(43) Pub. Date: Oct. 2, 2014

(54) SPEED READING BOOK FOR LEARNING CHINESE CHARACTERS

(71) Applicant: Jung Soo CHOI, Busan (KR)

(72) Inventor: Jung Soo CHOI, Busan (KR)

(21) Appl. No.: 14/242,685

(22) Filed: Apr. 1, 2014

(30) Foreign Application Priority Data
Apr. 2, 2013 (KR) 10-2013-0035785

(51) Int. Cl. G09B 19/08

(52) U.S. Cl. CPC G09B 19/08
USPC 434/157

(57) ABSTRACT

Provided is a speed reading book for learning Chinese characters, which enables students to learn various Chinese characters while receiving speed reading training by writing figures in Chinese characters, the speed reading book including: study pages that include: a training element for the enlargement of a perceptible visual field; and an element for utilizing Chinese radicals. According to the speed reading book for learning Chinese characters of the invention described herein, since the students may repetitively perform training for seeing a Chinese radical which is the basis for studying Chinese and relevant Chinese characters whose radical is a Chinese radical in a lump, the students can have an enlarged visual perception field, can strengthen their concentration and reading ability, and can remember the Chinese characters for a long time because the Chinese radicals of the relevant Chinese characters are acquired as images through repetitive studying.

### CROSS-REFERENCE TO RELATED APPLICATIONS

This application claims the benefit of Korean Patent Application No. 10-2013-0035785, filed on Apr. 2, 2013, entitled “Speed Reading Book for Learning Chinese Characters”, which is hereby incorporated by reference in its entirety into this application.

### BACKGROUND

1. Field of the Invention

The present invention relates, in general, to a speed reading book for learning Chinese characters, and more particularly, to a speed reading book for learning Chinese characters which can improve a reader's reading ability by utilizing Chinese characters and speed reading together for brain development, enabling the reader to learn Chinese characters easily and rapidly, remembering the acquired Chinese characters for a long time, and enabling his or her perceptible visual field to be enlarged and his or her concentration to be reinforced through an accurate and agile eye movement.

2. Description of the Related Art

Medically, the right brain handles pictures, images, imaginative power, creative ability, and the like, and the left brain handles cognitive skills related to linguistics, such as languages, words, reading, writing, and the like.

According to researchers, it has been proven that only left brain activity is associated with seeing Korean characters which are phonograms, whereas both left and right brain activity are associated with seeing Chinese characters.

The reason is because Chinese characters have complex letter forms, and are perceived as if they were images like pictures, and Chinese characters have clear meanings per the characters, thus the reader can recall the content of a Chinese character at the moment he or she sees it, thereby stimulating left and right brain activities.

Also, according to cerebral physiological experimental results of Dr. Tokizane Toshihiko, a professor at the Medical College of the University of Tokyo, it was confirmed that children who have steadily learned Chinese characters since childhood are highly intelligent compared to other children, and based on various tests and practices, Dr. Ishii Isao, who has engaged in Chinese character education all his life, also asserted that children should be taught Chinese characters because Chinese character education results in the child's brain development and children who studied the Chinese characters may become geniuses.

However, since the existing method for teaching Chinese characters is mainly performed by learning by rote, students easily forget the Chinese characters they have learned, thus putting the students under a lot of stress to retain what they have learned.

Speed reading, a reading method based on eye movement through spaces between the lines, is intended to sharpen skills for reading a book rapidly while simultaneously understanding the contents of the book, and is used by people who need to read quite a lot within a relative short amount of time or examinees who need to improve learning speed.

Speed reading ability is only improved through continuous study and repetition, nevertheless, in existing books for speed reading training, since the figures for speed reading training in the same shapes are continuously arranged, students frequently miss reading lines during speed reading training due to an optical illusion, so this can demotivate students for speed training. Furthermore, since the figures for speed reading training are very monotonous, students can easily lose interest in speed reading training, and thus in many cases the students neglect exercises for speed reading or give up the speed reading training.

Accordingly, the applicant of the present invention filed a patent application for a speed reading book for learning Chinese characters in which Chinese characters instead of figures are written, and a patent (see Korean Patent No. 10-0855202) was granted for the patent application.

Each of FIGS. 1A, 2A, 3A, 4A, and 5A show a study page in the speed reading book for learning Chinese characters according to the conventional art which was filed and granted in the name of the applicant of the present invention. FIG. 1A is used for strength training of eyesight and concentration, FIG. 2a for eye rotation training, FIG. 3A for attention strengthening training, FIGS. 4A and 5A for training for remembering Chinese characters for a long time.

However, speed reading books for learning Chinese characters lack a training element for the enlargement of the visual perception field which enables a reader to see letters in lumps as a main principle for speed reading training, and also lacks consideration regarding Chinese radicals which have become a basis for studying Chinese with regard to the selection and arrangement of Chinese characters to be acquired. Therefore, it has not sufficiently displayed the function of a speed reading book for learning Chinese characters capable of performing speed reading training and learning Chinese characters.

The foregoing is intended merely to aid in the understanding of the background of the present invention, and is not intended to mean that the present invention falls within the purview of the related art that is already known to those skilled in the art.

### SUMMARY

In one embodiment, provided is a speed reading book for learning Chinese characters which enables students' reading ability and concentration to be further improved by strengthening a training element for the enlargement of their visual perception field, thereby allowing a reader to look at letters, including Chinese characters, within the contents of the speed reading book for the learning of Chinese characters in lumps.

In another embodiment of the present invention, provided is a speed reading book for learning Chinese characters which can largely increase a learning effect for the Chinese characters by utilizing Chinese characters' radicals with regard to the selection and arrangement of the Chinese characters to be learned.

In yet another embodiment of the present invention, provided is a speed reading book for learning Chinese characters which can largely develop students' brains by integrating the speed reading training functions for the improvement of reading ability and concentration, including the brain development property of representing Chinese characters as ideograms.

In one embodiment, provided is a speed reading book for learning Chinese characters, which enables students to learn various Chinese characters while receiving speed reading training by writing figures in Chinese characters, the speed reading book including: study pages that include: a training element for the enlargement of a perceptible visual field, which allows the reader to see letters, including Chinese characters, all at once; and an element for utilizing Chinese radicals with regard to selection and arrangement of the Chinese characters.

Here, the training element for the enlargement of the perceptible visual field may include a first study page which is configured such that a Chinese radical and a translation thereof are printed in a square box, and an eye-shaped figure is additionally printed between the radical and the translation thereof, and a letter shape of each of the radical and the translation thereof is printed in an inverse image form.

Also, the training element for the enlargement of a visual perception field may include a second study page which is configured such that the study page is divided into an upper part and a lower part; respective Chinese radicals and Chinese numerals are printed on one end or another end of the study page in such a manner that the respective Chinese radicals and Chinese numerals are arranged on respective irregular lines by changing each of the relevant in a squiggly fashion; the respective Chinese radicals arranged at the one end, and the respective Chinese radicals or Chinese numerals arranged at the another end are connected to each other using respective irregular curved lines of a maze form; and respective separate Chinese radicals are additionally printed to be arranged in the center of the respective irregular lines.

Also, the training element for the enlargement of a visual perception field may include a third study page which is configured such that the inside of a numerical table is divided into various shapes of figures; Chinese numerals are randomly printed to be arranged inside the figures; and shades of the figures and boundary lines among the divided figures are printed to differ in thickness.

Also, the element for utilizing the Chinese radicals may include a fourth study page which is configured such that respective Chinese radicals for each subject are printed on one end in an inverse image form according to each line divided by horizontal lines; relevant translations of the Chinese radicals for each subject arranged at the one end are printed on another end of each of the same lines as the lines on which the Chinese radicals for each subject are printed; according to the spaces of lines formed among the Chinese radicals for each subject of the one end and the relevant translations of the another end, relevant Chinese characters whose radicals are the Chinese radicals for each subject of the lines, and translations thereof, blanks for Chinese writing which allow the students to fill in only writable Chinese radicals of the respective lines are printed.

Also, the element for utilizing the Chinese radicals may include a fifth study page which is configured such that a Chinese unit radical, and respective relevant Chinese characters whose radical is the Chinese unit radical make a pair with respective translations thereof, are printed in an inverse image form according to each line divided by horizontal lines; and according to a space in lines formed between a set of the Chinese unit radical arranged at the one end, the relevant Chinese character, and the translation thereof, and a set of the relevant Chinese characters and the translation thereof, respective blanks for Chinese writing which allows the students to fill in only Chinese characters acquired in the respective lines, and respective figures to lead eye movement from the students are printed.

In one embodiment of the speed reading book for learning Chinese characters of the present invention, since the students may repetitively perform training for seeing a Chinese radical, relevant Chinese characters whose radical is the Chinese radical, translations thereof in lumps, it is advantageous in that the students can have an enlarged visual perception field, can strength their concentration and reading ability, and can enable them to remember the Chinese characters for a long time because of the Chinese radical, which is a basis for studying Chinese, and the relevant Chinese characters, whose radical is a Chinese radical, are acquired as images through repetitive studying.

In another embodiment of the speed reading book for learning Chinese characters of the present invention, since a Chinese radical is selected according to subjects relating to ‘a person’, ‘a face’, and the like, such as ‘16 radicals’ regarding ‘the person’, 22 radicals regarding ‘the face’, and the like, with regard to the selection and arrangement of Chinese characters, relevant Chinese characters whose radical is the Chinese radical are arranged on the same study line as that of the Chinese radical for each subject, and a Chinese unit radical in a simple form is selected and relevant Chinese characters whose radical is the Chinese unit radical are arranged within the same study scope as that of the Chinese unit radical, it is advantageous in that the students can impliedly master the principles of creation for Chinese characters including the concepts of radicals while receiving training.

Furthermore, in another embodiment, the speed reading book for learning Chinese characters of the present invention has both a function to increase activities of the left brain and right brain resulting from the training for enlarging a visual perception field, and a property of brain development possessed by representing Chinese characters as ideograms, therefore, it has the best effect as a teaching material for the development of the brain and corresponding talents in children.

### BRIEF DESCRIPTION OF THE DRAWINGS

The above and other features of the present invention will be more clearly understood from the following detailed description when taken in conjunction with the accompanying drawings, in which:

FIGS. 1A, 2A, 3A, 4A and 5A are views showing pages used for learning in a speed reading book for the learning of Chinese characters according to a conventional art; and

FIGS. 1B, 2B, 3B, 4B and 5B are views showing first, second, third, fourth, and fifth pages for used for learning in a speed reading book for the learning of Chinese characters according to an embodiment of the present invention.

### DETAILED DESCRIPTION

Embodiments of the present invention will now be described in detail below with reference to the accompanying drawings, and it should be understood that the present invention should not be limited to the described embodiments.

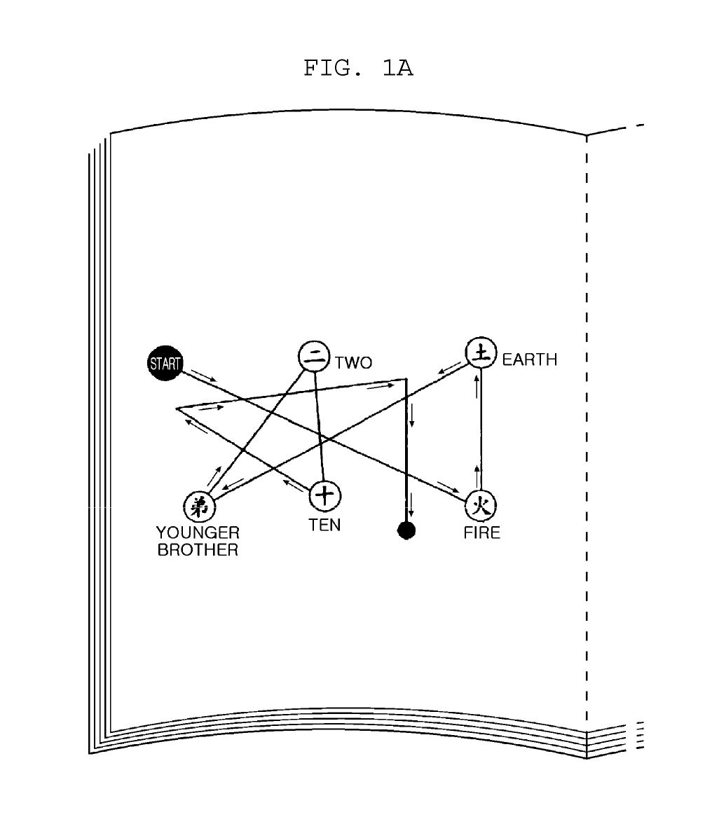

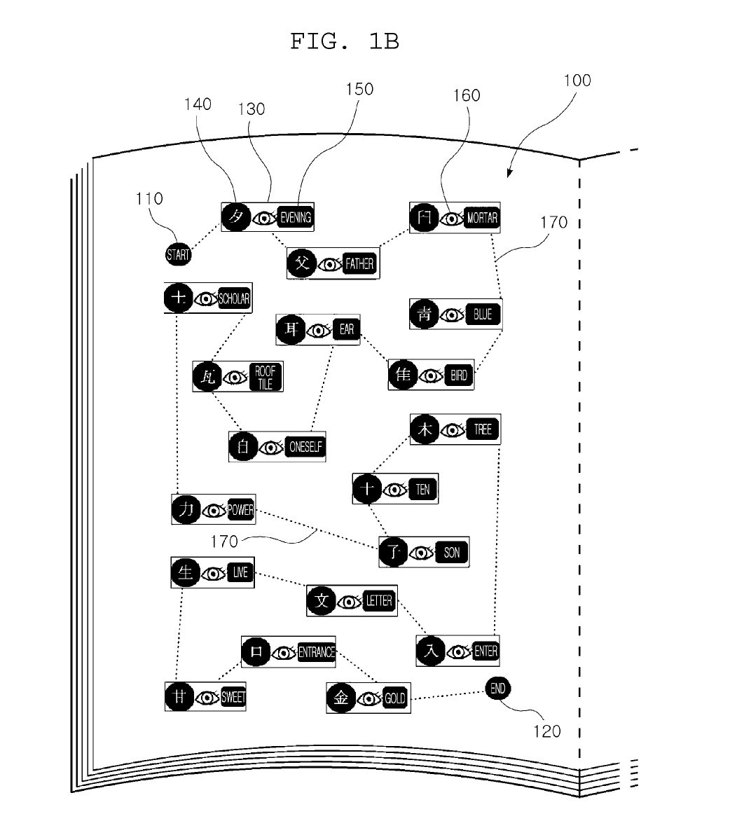

FIG. 1B is a view showing a first study page in a speed reading book for learning Chinese characters according to an embodiment of the present invention.

The first study page is configured such that a Chinese radical 140 and a translation 150 thereof are printed in each of several square boxes 130; an eye-shaped FIG. 160, which suggests seeing the Chinese character's radical 140 and the Korean translation 150 thereof in a lump, is additionally printed between the Chinese radical 140 and the translation 150 thereof; a letter shape of each of the Chinese radical 140 and the Korean translation 150 thereof is printed in an inverse image form so that a reader can easily see the Chinese radical 140 and the translation 150 thereof in a lump by concentrating his or her mind on the Chinese radical 140 and the Korean translation 150 thereof; and each of the several square boxes 130 are connected by diagonal lines 170 for connecting a starting point 110 and an end point 120 in a zigzag form.

Thanks to such a configuration of the first study page, students can repeatedly perform training for enlarging a visual perception field in such a manner as to see the Chinese character's radical 140 and the translation 150 thereof in a lump while following the diagonal lines 170 from the starting point 110 to the end point 120 at high speed so that the students can improve their reading ability and concentration, and can naturally acquire various Chinese characters.

In one embodiment, a training procedure of the first study page is as follows.

Students must not speak during training, but must move only their pupils along the diagonal lines 170 from the starting point 110 and the end point 120 according to a guidance teacher's instructions, and at this time, the students' optic nerves and cranial nerves begin to move along with the movement of their pupils.

In this way, when the pupils reach the Chinese radical 140 ‘ [symbol] ’ and the translation thereof 150 ‘evening’ in the square box 130, the movement of the pupils stops.

Furthermore, by the suggestive action of the eye-shaped FIG. 160, which is printed between the Chinese radical 140 and the translation 150 thereof, to suggest seeing the Chinese character's radical 140 and the translation 150 thereof in a lump, the students rapidly perform left and right flow of their pupils out of awareness, thereby seeing the Chinese radical 140 and the translation 150 thereof in a lump. As such, at the moment they see the Chinese radical 140 and the translation 150 thereof in a lump, their left brains and right brains become active. As a result, their brains are revitalized, and at the same time, concentration is strengthened, and the Chinese radicals remain in the students' memories for a long time because the Chinese radicals are transferred to the brain as images thanks to the repetitive eye movements.

In sequence, when the pupils move along the diagonal lines 170 from starting at the square box 130 in which the Chinese radical 140 and the translation 150 thereof are printed, the pupils reach another Chinese radical 140 ‘ [symbol] ’ and the translation 150 thereof ‘father’ in another square box 130, and at this time, as described above, another Chinese radical 140 and the translation 150 thereof remain in the students' memories in a lump because the students see them at once.

The students remember the Chinese radical 140 and the translation 150 thereof in the square box 130 by moving only their pupils along the diagonal line 170 in a lump, and the movement of their pupils stop after their pupils have reached the end point 120.

Then, the guidance teacher gives the students instructions to start eye movement again from the starting point 110, as described above, or instructions to start eye movement in a reverse direction from the end point 120.

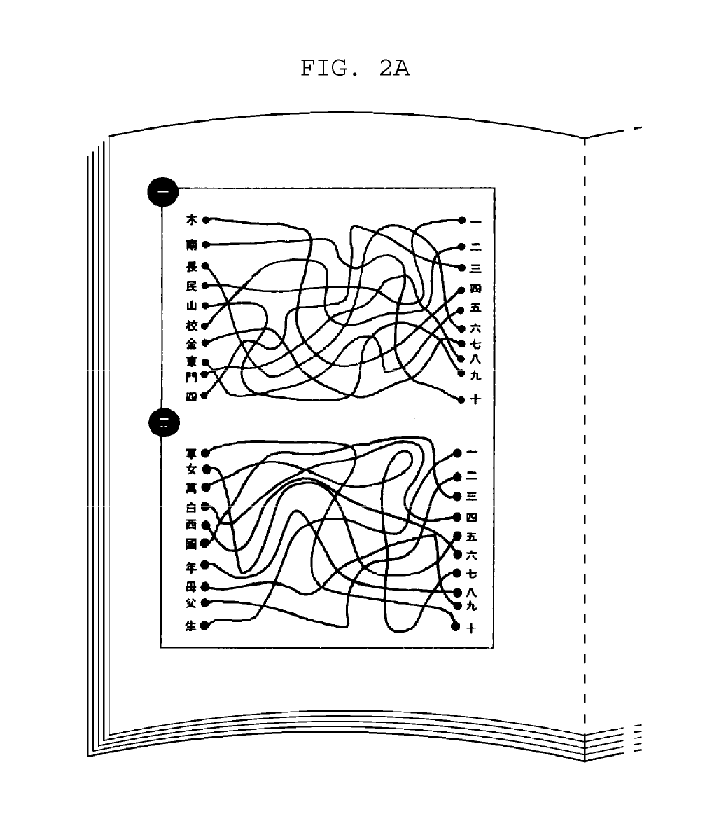

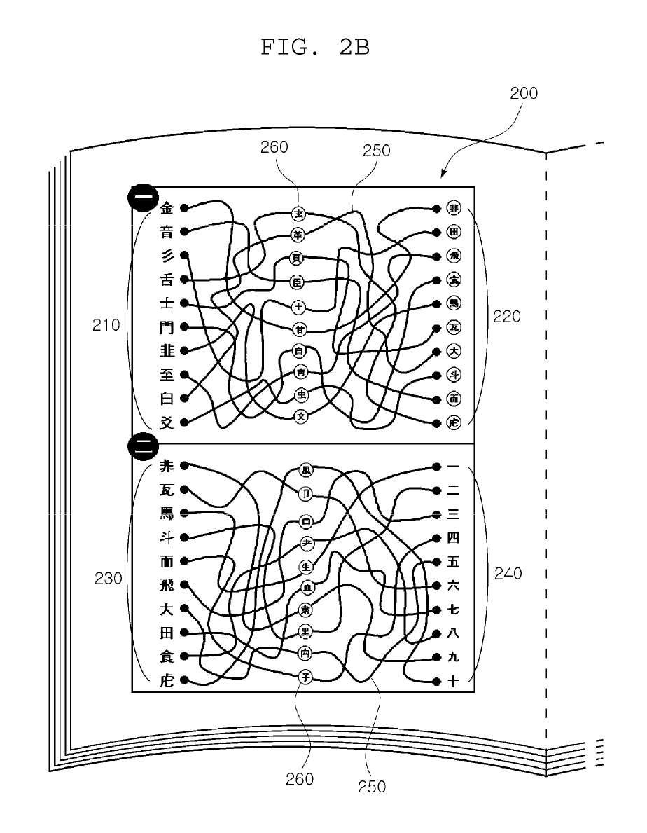

FIG. 2B is a view showing a second study page of the speed reading book for learning Chinese characters according to one embodiment of the present invention.

The second study page is divided into an upper part and a lower part, and respective Chinese radicals 210, 220, 230 and Chinese numerals 240 are printed on irregular lines by changing the lines up and down, and the Chinese radicals 210 and 230 arranged at one end, and the Chinese radicals 220 arranged at another end or the Chinese numerals 240 are connected to each other using irregular curved lines 250, and separate Chinese radicals 260 are additionally printed in the center of the irregular curved lines 250.

Thanks to such a configuration of the second study page, the students can repetitively perform training for seeing the Chinese radicals 210 and 230 arranged at the one end and the Chinese radical 260 arranged in the center in a lump during the eye movement that starts from the Chinese radicals 210 and 230 arranged at the one end and reaches the Chinese radical 220 or the Chinese numeral 240 arranged at the another end along the irregular curved lines 250, or training by seeing the Chinese radical 260 arranged in the center and the Chinese radical 220 arranged at the another end or the Chinese numeral 240 in a lump so that the students can have an enlarged visual perception field resulting from increases in the movement of the eyes (i.e., rapid movement of the pupils), can have improved concentration and reading ability, and can remember the Chinese characters for a long time because the Chinese radicals 210, 220, 230, 260 are acquired as images by repetitive study.

In one embodiment, a training procedure of the second study page is as follows.

According to the guidance teacher's instructions, the students see the Chinese radical 210 ‘ [symbol] ’ arranged at one end on an upper left side of the study page divided into upper and lower parts, and the Chinese radical 260 ‘ [symbol] ’ arranged in the center and connected to the Chinese radical ‘ [symbol] ’ by the irregular curved line 250 in a lump by performing movement of their pupils rapidly, and subsequently, the students also see the Chinese radical 220 ‘ [symbol] ’ arranged at another end on the right side and connected to the Chinese radical 260 ‘ [symbol] ’ arranged in the center and the Chinese radical ‘ [symbol] ’ by the irregular curved line 250 in a lump by performing movement of their pupils rapidly.

Then, the students find the Chinese radical ‘ [symbol] ’, which they have just seen, from a group of the Chinese radicals 230 arranged at one end on the left side and printed in the lower part of the study page and see the Chinese radical ‘ [symbol] ’ and the Chinese radical 260 ‘ [symbol] ’ arranged in the center and connected to the Chinese radical ‘ [symbol] ’ by the irregular curved line 250 in a lump again by performing movement of their pupils rapidly, and thereafter, the students subsequently see the Chinese radical 260 ‘ [symbol] ’ arranged in the center, and a Chinese numeral 240 ‘ [symbol] ’ arranged at the another end on the right side and connected to the Chinese radical ‘ [symbol] ’ by the irregular curved line 250 in a lump by performing movement of their pupils rapidly.

Then, a student who reaches the Chinese numeral 240 [symbol] indicates it with their finger.

In the training procedure of this study page, the students must not “see” the irregular curved line 250 while following it with their fingers or the like, but may only use their pupils to move along the irregular curved line 250, and a student who reaches a targeted point (e.g., a student who finds a corresponding numeral) raises his or her hand quietly so that the guidance teacher can confirm it.

After this, according to the guidance teacher's instructions, the students see the Chinese radical 210 [symbol] arranged at one end on the left side and printed in the upper part of the study page and the Chinese radical 260 ‘ [symbol] ’ connected thereto and arranged in the center in a lump in the same way as that of the training procedure as described above, and subsequently, the students see the Chinese radical 260 ‘ [symbol] ’ arranged in the center and a Chinese character 220 ‘ [symbol] ’ connected thereto and arranged at the other end on the right side in a lump, and find the Chinese radicals they have just seen from the group of the Chinese radicals 230 arranged at the one end on the left side and printed in the lower part of the page, and see the Chinese radical ‘ [symbol] ’ and a Chinese radical ‘ [symbol] ’ connected thereto and arranged in the center in a lump again. At this time, a student who reaches the Chinese numeral 240 ‘ [symbol] ’ connected to the Chinese radical ‘ [symbol] ’ arranged in the center raises his or her hand quietly while indicating the Chinese numeral 240 ‘ [symbol] ’ with their finger so that the guidance teacher can confirm it.

The students remember the Chinese radicals 210, 220, 230, and 260 for a long time because these Chinese radicals are acquired as images through repetitive study performed by reading the Chinese radicals in such a way.

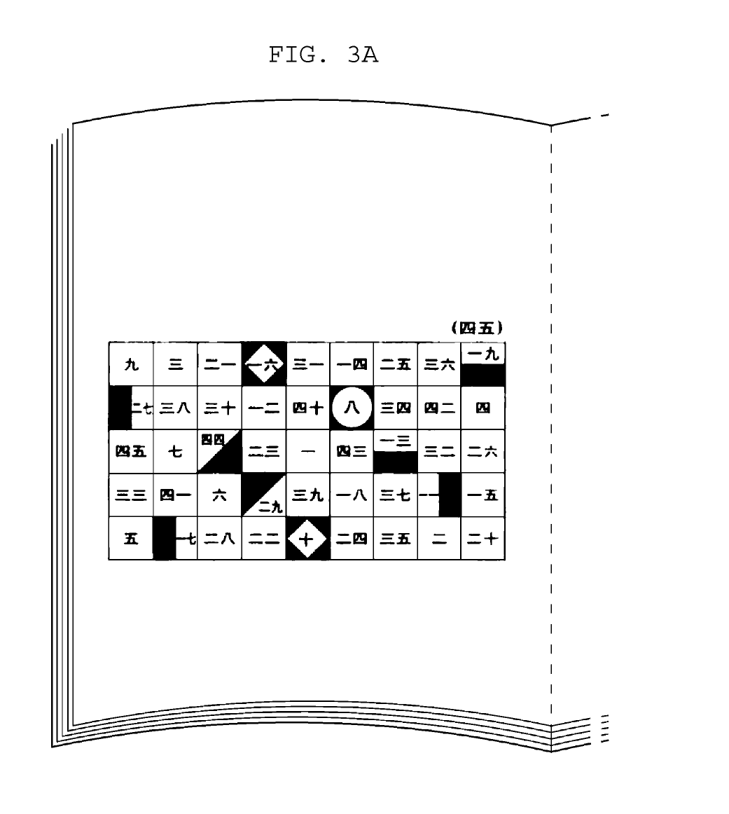

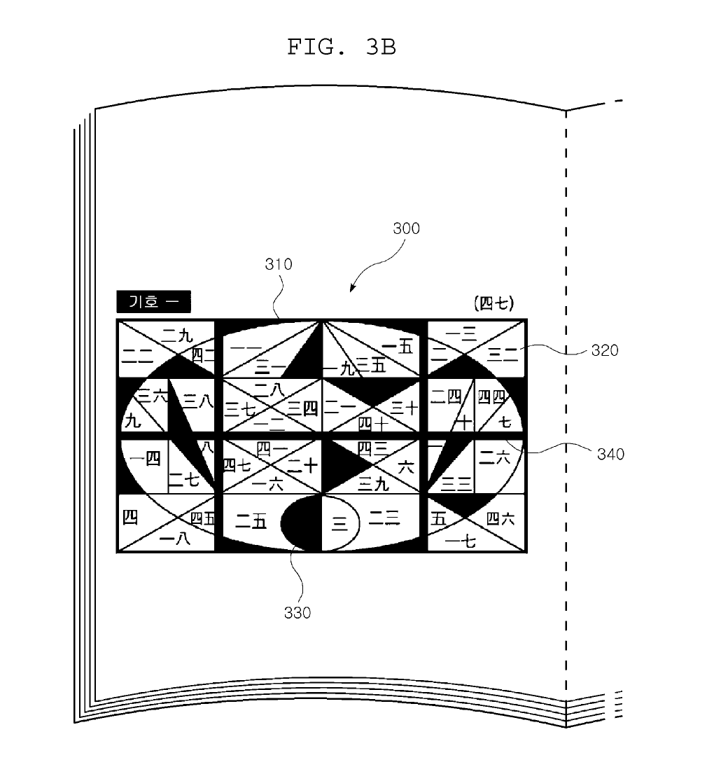

FIG. 3B is a view showing a third study page of the speed reading book for learning Chinese characters according to another embodiment of the present invention.

The third study page is configured such that the inside of a numerical table 310 is divided into various small or large shapes of figures; Chinese numerals 320 are randomly printed inside the figures; shades 330 of the figures and boundary lines 340 among the divided figures are printed to differ in thickness.

Thanks to such a configuration of the third study page, the students can repetitively perform a training for seeing various figures in a small, middle, or large range in the numerical table 310 in a lump in various ways, and a training for seeing the

Chinese numerals 320 printed in each of the figures in a lump in various ways throughout a small, middle, or large range in finding a Chinese numeral 320 matched with the teacher's instructions among the Chinese numerals 320 arranged in the numerical table 310 so that the students can have an enlarged visual perception field, can improve concentration, and largely develop their brains.

In one embodiment, a training procedure of the third study page is as follows.

First, as a training method for finding the word for a numeral, when the teacher instructs “the students to speak the position of a Chinese numeral ‘ [symbol] ’ loudly if they find the Chinese numeral,” the students find the Chinese numeral ‘ [symbol] ’ in such a manner as to rapidly move their pupils leftward, rightward, upward, or downward within an area indicated by a large oval and see the Chinese numerals 320 in a lump within the area.

When none of the students find the Chinese numeral ‘ [symbol] ’ within the area indicated by the large oval quickly, the students may find the Chinese numeral ‘ [symbol] ’ in such a manner as to see the Chinese numerals 320 in a lump while rapidly moving their pupils as described above within an area of the figures arranged at the four corners, except for roughly the area indicated by the large oval.

In spite of this, when still none of the students find the Chinese numeral ‘ [symbol] ’ quickly, the students may find the Chinese numeral ‘ [symbol] ’ in such a manner as to see the Chinese numerals 320 arranged at a center part of the numerical table 310 and being within the sections divided by a thick line in a lump in the way as described above, and subsequently, find the Chinese numeral ‘ [symbol] ’ within remaining sections, except for the above sections in the area indicated by the large oval.

However, even via such a way, when still none of the students find the Chinese numeral ‘ [symbol] quickly, they may find the Chinese numeral ‘ [symbol] ’ within further divided sections resulting from dividing the sections they have just seen in a lump into an upper part and a lower part, or remaining sections, except for the divided sections, and in spite of this, when the students find the Chinese numeral, they may find the Chinese numeral by further specifying the sections.

The third study page enables the students to simultaneously perform training for seeing letters as concentrated lumps and training for attending to what the teacher says. For example, like the aforesaid training for finding the word of a numeral, when the teacher instructs the students to find a Chinese numeral corresponding to “15”, the students may find the Chinese numeral ‘ [symbol] ’ even though they hear it just once, but when the teacher instructs the students “to find a Chinese numeral corresponding to a value resulting from calculating 3 plus 12”, the students must carefully hear what the teacher says because they must hear ‘3’, ‘+’, and ‘12’ what the teacher has instructed to find the corresponding Chinese numeral in a lump and must find the calculated value.

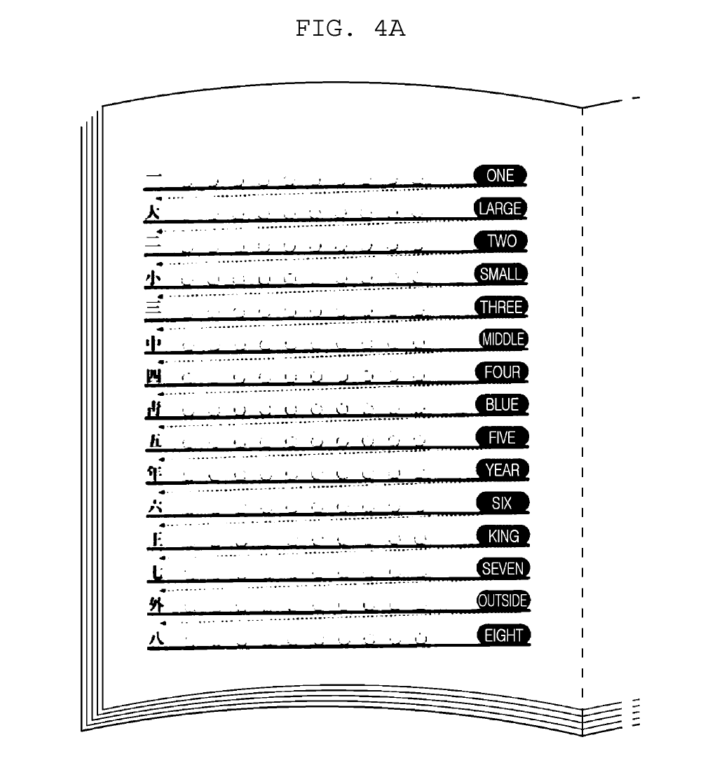

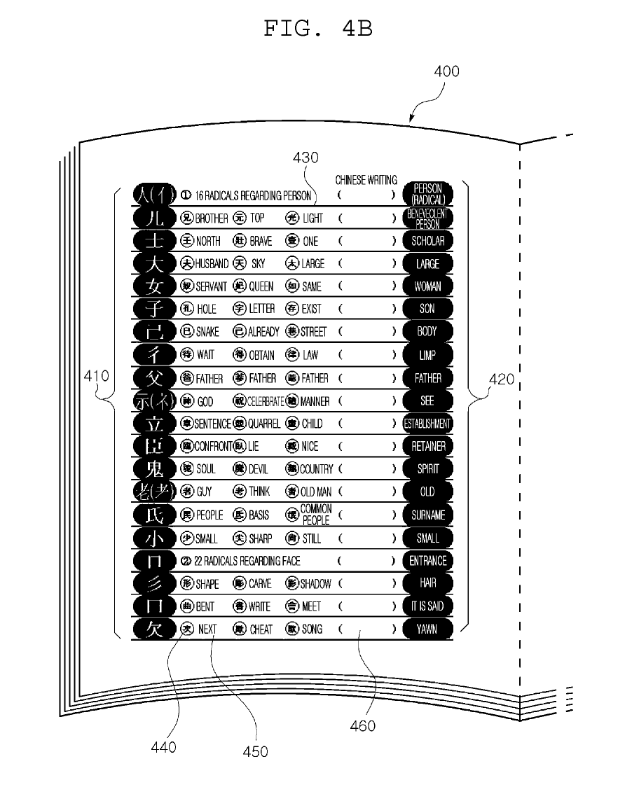

FIG. 4B is a view showing a fourth study page of the speed reading book for learning Chinese characters according to one embodiment of the present invention.

The fourth study page is configured such that respective Chinese radicals 410 for subjects relating to ‘a person’, ‘a face’, and the like, such as ‘16 radicals regarding ‘the person’, 22 radicals regarding ‘the face’, and the like, are printed on one end of the page in an inverse image form according to each of lines divided by underlined parts 430; respective translations 420 equivalent to the respective Chinese radicals 410 per each subject are arranged at one end and are printed on another end in an inverse image form on the same line as each of the lines in which the respective Chinese radicals for each subject are printed; and according to the respective spaces on the lines formed among the Chinese radicals 410 per each subject arranged at the one end and the translations 450 thereof, respective Chinese characters 440 which have the respective Chinese radicals for each subject of each of the lines as their respective radicals, respective translations 450 thereof, and respective blanks 460 to write the respective Chinese characters are printed.

As such, thanks to the configuration of the fourth study page, the students may repeatedly perform training for seeing the Chinese radical 410 for each subject arranged at one end and the translation 420 thereof arranged at the another end in a lump so that the students' left and right brains can be largely revitalized, the students can largely improve concentration and reading ability and can remember the Chinese radicals and Chinese characters related thereto for a long time because these Chinese radicals and characters are transferred to the their brains as images by repetitive eye movement.

Also, as described above, on the fourth study page, the respective Chinese radicals are selected according to the subjects relating to ‘a person’, ‘a face’, and the like, such as ‘16 radicals regarding ‘the person’, 22 radicals regarding ‘the face’, and the like, and the respective Chinese characters which have the respective Chinese radicals for each subject as their relevant radicals are arranged on the same respective study lines as the respective study lines on which the respective Chinese radicals are arranged so that the students can impliedly master the principles of creation of Chinese characters, including the concepts of radicals, while receiving training.

In one embodiment, a training procedure of the fourth study page is as follows.

According to the teacher's instructions, the students first see the Chinese radical ‘ [symbol] ’, among 16 Chinese radicals 410 regarding the person printed at the one end on the left side, and then see the translation 420 ‘person’ thereof arranged at the another end on the right side, and thus when the students already know the Chinese radical ‘ [symbol] ’, their eyes move to a line just below the line without further delay.

However, when the students don't know the Chinese radical ‘ [symbol] ’, they see the translation 420 ‘person’ arranged at the another end on the right side and the Chinese radical 410 arranged at the one end on the left side in a lump by moving their pupils rapidly, and then see the Chinese radical 410 arranged at the one end on the left side once again, and also see the translation 420 ‘person’ thereof arranged at the another end on the right side once again.

The students perform training for seeing the Chinese radical 410 arranged at the one end on the left side and the translation 420 thereof arranged at the another end on the right side in a lump for 40 seconds (i.e., even though there are students who will not complete the training up to the last line of the page in 40 seconds, they will still stop with the training at 40 seconds) by moving their eyes to each line in order, and thereafter, the teacher allows the students to cover the Chinese radicals 410 arranged at the one end on the left side with a paper band in order to see only the translations thereof arranged at the another end on the right side, and then allows the students to fill in only the writable respective Chinese radicals in the respective blanks 460 to write the respective Chinese characters for 30 seconds.

The students who have completed the writing of the Chinese characters within 30 seconds should continuously perform the training to see the relevant respective Chinese characters 440 and respective translations 450 thereof arranged on each line in a lump for the remaining time.

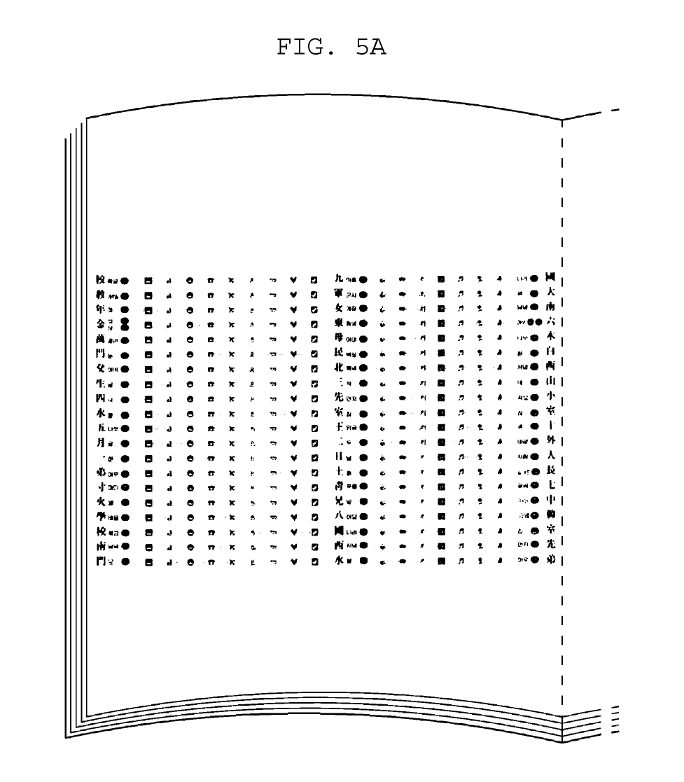

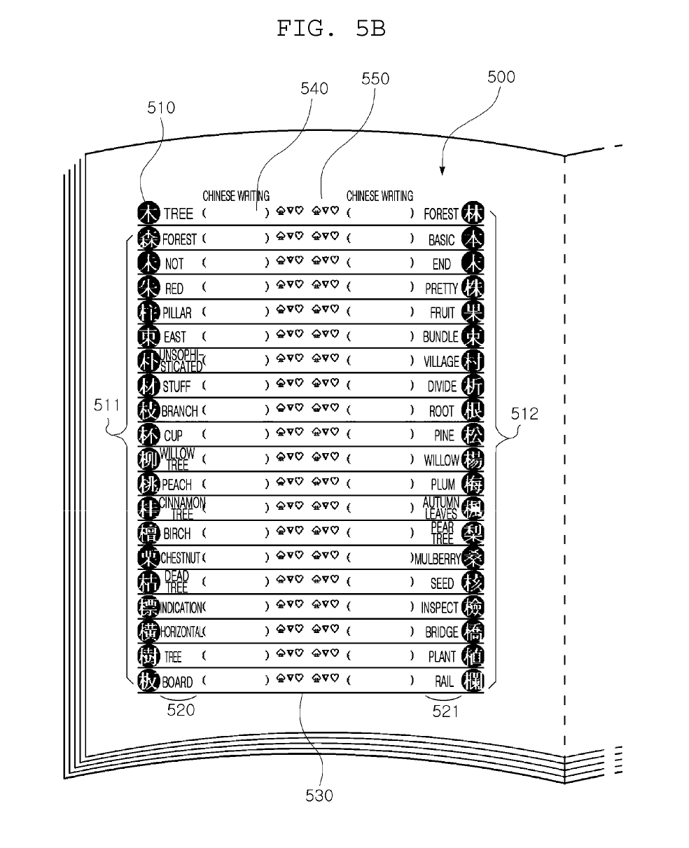

FIG. 5B is a view showing a fifth study page of the speed reading book for learning Chinese characters according to another embodiment of the present invention.

The fifth study page is configured such that respective Chinese unit radicals 510, such as ‘ [symbol] ’, and respective relevant Chinese characters 511 and 512, such as ‘ [symbol] ’, ‘ [symbol] ’, ‘ [symbol] ’, ‘ [symbol] ’, ‘ [symbol] ’, ‘ [symbol] ’ which have the Chinese radical ‘ [symbol] ’ as their radical, make a pair with their respective translations 520 and 521, and thus they are printed according to each line in an inverse image form; and according to a space on the line formed between a set of the Chinese unit radical 510 arranged at the one end, the relevant Chinese character 511, and the translation 520 thereof, and a set of the relevant Chinese character 512 and the translation 521 thereof, respective blanks 540 to write Chinese characters, which allows the students to fill only Chinese characters acquired in the respective lines, and FIGS. 550 to lead eye movement from the students are printed.

As such, thanks to the configuration of the fifth study page, the students may repeatedly perform training for seeing the Chinese unit radical 510, the relevant Chinese character 511, the translations 520 and 521 thereof in a lump so that the students' left and right brains can be largely revitalized, the students can largely improve their concentration and reading ability, and can remember the Chinese unit radicals and the relevant Chinese characters for a long time because these Chinese unit radicals and characters are transferred to the their brains as images by repetitive eye movement.

Also, as described above, on the fifth study page, the Chinese unit radicals in a simple form are selected, and the relevant Chinese characters which have the Chinese unit radicals as their radicals are systematically arranged within the same studying scope as that of the Chinese unit radicals so that the students can impliedly master the principles of creation for Chinese characters including the concepts of radicals while receiving training.

In one embodiment, a training procedure of the fifth study page is as follows.

According to the teacher's instructions, the students see the Chinese unit radical 510 ‘ [symbol] ’ and the translation 520 thereof ‘tree’ printed at the one end on the left side in a lump in such a manner as to see the Chinese unit radical and the translation thereof only one time when they already know the Chinese unit radical, and see the Chinese unit radical and the translation thereof two times when they do not know the Chinese unit radical.

Subsequently, the students see the relevant Chinese radical 512 ‘ [symbol] ’ and the translation 521 thereof ‘forest’ printed at the another end on the right side in a lump by performing movement of their pupils rapidly along the FIGS. 550 in such a manner as to see the Chinese radical and the translation thereof only one time when they already know the Chinese radical, and see the Chinese radical and the translation thereof two times when they do not know the Chinese unit radical.

While moving their eyes to the lower lines in order, in such a way, the students perform training for seeing the Chinese unit radical 510, the relevant Chinese character 511 and the translation 520 thereof arranged at the one end on the left side in a lump, and subsequently, perform training for seeing the relevant Chinese character 512 and the translation 521 thereof arranged at the another end on the right side in a lump for 40 seconds (i.e., even though there are students who will not complete the training up to the last line of the page in 40 seconds, they will still stop with the training at 40 seconds), and thereafter, the teacher allows the students to cover the Chinese unit radical 510 and the relevant Chinese characters 511 and 521 arranged at the one end on the left side or the another end on the right side with a paper band so as to see only the translations 520 and 521 thereof, and then allows the students to fill in only the writable respective Chinese characters in the respective blanks 540 to write respective Chinese characters for 30 seconds.

Although embodiments of the present invention have been described for illustrative purposes, those skilled in the art will appreciate that various modifications, additions, and substitutions are possible, without departing from the scope and spirit of the invention as disclosed in the accompanying claims.

What is claimed is:

1. A speed reading book for learning Chinese characters, which enables students to learn various Chinese characters while receiving speed reading training by writing figures in Chinese characters, the speed reading book comprising:
study pages including:
a training element for the enlargement of a perceptible visual field, which enables the students to see letters including Chinese characters all in a lump; and
an element for utilizing Chinese radicals with regard to selection and arrangement of Chinese characters;
wherein the training element for the enlargement of the perceptible visual field includes a first study page which is configured such that a Chinese radical and a translation thereof is printed in a square box; an eye-shaped figure is additionally printed between the Chinese radical and the translation thereof; and a letter shape of each of the Chinese radical and the translation thereof is printed in an inverse image form.

2. A speed reading book for learning Chinese characters, which enables students to learn various Chinese characters while receiving speed reading training by writing figures in Chinese characters, the speed reading book comprising:
study pages including:
a training element for the enlargement of a perceptible visual field, which enables the students to see letters including Chinese characters all in a lump; and
an element for utilizing Chinese radicals with regard to selection and arrangement of Chinese characters;
wherein the training element for the enlargement of the perceptible visual field includes a second study page which is configured such that the study page is divided into an upper part and a lower part; respective Chinese radicals and respective Chinese numerals are printed on one end or another end of the study page in such a manner that the respective Chinese radicals and the respective Chinese numerals are arranged on irregular lines by changing the relevant lines up and down; the respective Chinese radicals arranged at one end and the respective Chinese radicals or Chinese numerals arranged at another end are connected to each other using respective irregular curved lines of a maze form; and separate respective Chinese radicals arranged in the center are additionally printed to be arranged on the respective irregular lines.

3. A speed reading book for learning Chinese characters, which enables students to learn various Chinese characters while receiving speed reading training by writing figures in Chinese characters, the speed reading book comprising:
study pages including:
a training element for the enlargement of a perceptible visual field, which enables the students to see letters including Chinese characters all in a lump; and
an element for utilizing Chinese radicals with regard to selection and arrangement of Chinese characters;
wherein the training element for the enlargement of the perceptible visual field includes a third study page which is configured such that the inside of a numerical table is divided into various shapes of figures; Chinese numerals are randomly printed to be arranged inside the figures; and shades of the figures and boundary lines among the divided figures are printed to differ in thickness.

4. A speed reading book for learning Chinese characters, which enables students to learn various Chinese characters while receiving speed reading training by writing figures in Chinese characters, the speed reading book comprising:
study pages including:
a training element for the enlargement of a perceptible visual field, which enables the students to see letters including Chinese characters all in a lump; and
an element for utilizing Chinese radicals with regard to selection and arrangement of Chinese characters;
wherein the element for utilizing the Chinese radicals includes a fourth study page which is configured such that respective Chinese radicals for each subject are printed on one end in an inverse image form according to each line divided by horizontal lines; relevant respective translations of the Chinese radicals for each subject of one end are printed on another end of each of the same lines as the lines on which the Chinese radicals for each subject are printed; according to spaces on lines formed among the Chinese radicals for each subject of one end and the relevant translations of another end, relevant Chinese characters whose radicals are the Chinese radicals for each subject of the lines, and translations thereof, blanks for Chinese writing which allow for filling in of only writable Chinese radicals of the respective lines are printed.

5. A speed reading book for learning Chinese characters, which enables students to learn various Chinese characters while receiving speed reading training by writing figures in Chinese characters, the speed reading book comprising:
study pages including:
a training element for the enlargement of a perceptible visual field, which enables the students to see letters including Chinese characters all in a lump; and
an element for utilizing Chinese radicals with regard to selection and arrangement of Chinese characters;
wherein the element for utilizing the Chinese radicals includes a fifth page which is configured such that a Chinese unit radical and respective relevant Chinese characters whose radical is the Chinese unit radical make a pair with respective translations thereof, and are printed in an inverse image form according to each line divided by horizontal lines; and according to a space on a line formed between a set of the Chinese unit radical arranged at one end, the relevant Chinese character, and the translation thereof, and a set of the relevant Chinese character and the translation thereof, respective blanks for Chinese writing which allows for the students to fill in only the Chinese characters acquired on the respective lines, and respective figures to lead eye movement from the students are printed.

6. A speed reading book for learning Chinese characters, which enables students to learn various Chinese characters while receiving speed reading training by writing figures in Chinese characters, the speed reading book comprising:
a first study page which is configured such that a Chinese radical and a translation thereof are printed in a square box; an eye-shaped figure is additionally printed between the Chinese radical and the translation thereof; and a letter shape of each of the Chinese radical and the translation thereof is printed in an inverse image form;
a second study page which is configured such that the study page is divided into an upper part and a lower part; respective Chinese radicals and respective Chinese numerals are printed on one end or another end of the study page in such a manner that the respective Chinese radicals and the respective Chinese numerals are arranged on irregular lines by changing the relevant lines up and down; the respective Chinese radicals arranged at one end and the respective Chinese radicals (220) or Chinese numerals arranged at another end are connected to each other using respective irregular curved lines of a maze form; and separate respective Chinese radicals arranged in the center are additionally printed to be arranged on the respective irregular lines;
a third study page which is configured such that the inside of a numerical table is divided into various shapes of figures; Chinese numerals are randomly printed to be arranged inside the figures; and shades of the figures and boundary lines among the divided figures are printed to differ in thickness;
a fourth study page which is configured such that respective Chinese radicals for each subject are printed on one end in an inverse image form according to each line divided by horizontal lines; relevant respective translations of the Chinese radicals for each subject of one end are printed on another end of each of the same lines as the lines on which the Chinese radicals for each subject are printed; according to the spaces on lines formed among the Chinese radicals for each subject of one end and the relevant translations of another end, relevant Chinese characters whose radicals are the Chinese radicals for each subject of the lines, and translations thereof, blanks for Chinese writing which allow for filling in of only writable Chinese radicals of the respective lines are printed; and
a fifth page which is configured such that a Chinese unit radical, respective relevant Chinese characters whose radical is the Chinese unit radical make a pair with respective translations thereof, and printed in an inverse image form according to each line divided by horizontal lines; and according to a space on a line formed between a set of the Chinese unit radical arranged at the one end, the relevant Chinese character, and the translation thereof, and a set of the relevant Chinese character and the translation thereof, respective blanks for Chinese writing which allows for the students to fill in only Chinese characters acquired on the respective lines, and respective figures to lead eye movement from the students are printed.
